(19) United States
(12) Patent Application Publication
(10) Pub. No.: US 2008/0059213 A1
(43) Pub. Date: Mar. 6, 2008

(54) Address database coding

(76) Inventor: Mark Gundersen, Manchester, CT (US)

Correspondence Address: Kirkpatrick & Lockhart Preston Gates Ellis LLP;(FORMERLY KIRKPATRICK & LOCKHART NICHOLSON GRAHAM), STATE STREET FINANCIAL CENTER, One Lincoln Street, BOSTON, MA, 02111-2950, US

(21) Appl. No.: 11/517,113

(22) Filed: Sep. 6, 2006

(51) Int. Cl. G06Q 99/00

(52) U.S. Cl. 705/1

(57) ABSTRACT

A method for coding a plurality of postal addresses. The method includes associating an identifier with a postal address having a first plurality of elements, and associating the identifier with a second plurality of elements if the second plurality of elements is associated with the postal address.

### SUMMARY OF THE INVENTION

An embodiment of the present invention relates to a method for coding a plurality of postal addresses with unique identifiers. The method includes associating an identifier with a postal address having a first plurality of elements and associating the identifier with a second plurality of elements if the second plurality of elements is also associated with the postal address.

### DESCRIPTION OF THE FIGURES

For the present invention to be understood clearly and readily practiced, the present invention will be described in conjunction with the following figures, wherein:

FIG. 1 is a process diagram that illustrates an exemplary method for practicing an embodiment of the present invention;

FIG. 2 is an exemplary chart that illustrates address relationships identified in accordance with an embodiment of the present invention; and

FIG. 3 is a schematic block diagram illustrating a suitable operating environment in accordance with an embodiment of the present invention.

### DESCRIPTION

An embodiment of the present invention relates to a system and method for assigning a unique identifier to a postal address, wherein the unique identifier is independent of changes to the elements of the postal address. For example, “101A Main St.” may be changed to “101 Main St., Apt. A.” In this example, the postal address is the same (i.e., same delivery location), but the elements associated with the postal address have changed, namely the street number and secondary unit designator. According to an embodiment, the first plurality of elements (“101A Main St.”) and the second plurality of elements (“101 Main St., Apt. A”) are both associated with the same identifier. Those of ordinary skill in the art will appreciate that the elements of a postal address may change in a variety of ways to accommodate, for example, address renumbering and street renaming.

In the following discussion of illustrative embodiments, the term “postal address” refers to a physical location, such as a business or residence, that can accept the delivery of mail. The term “element,” as used herein, may be any component of a postal address including, but not limited to, street number, apartment number, street name, city or town name, or zip code. In that regard, “a plurality of elements” or “plurality of address elements” refers to any set of elements necessary to facilitate delivery to the associated postal address. The term “address record,” as used herein, collectively refers to an address, including one or more pluralities of elements, and, optionally, an identifier according to the present invention.

It is to be understood that the figures and descriptions of the present invention have been simplified to illustrate elements that are relevant for a clear understanding of the present invention while eliminating, for purposes of clarity, other elements. For example, certain details relating to the generation of a unique identifier is not described herein. A detailed discussion of such an algorithm is not provided because such a process is well known in the art and because it does not facilitate a better understanding of the present invention.

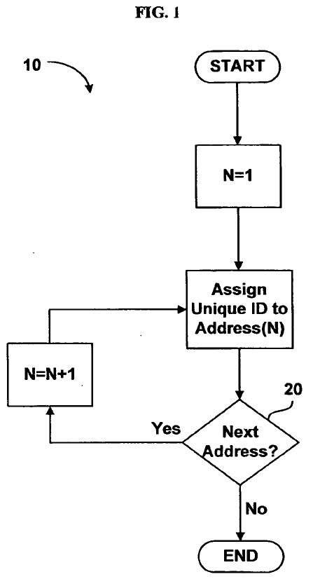

FIG. 1 is an exemplary block diagram that illustrates a method 10 for assigning unique identifiers to a plurality of postal addresses according to an embodiment of the present invention. In step 15, a counter N is set to 1 and, in step 20, a unique identifier is assigned to an address(N). In step 25, method 10 determines whether additional addresses require coding. If “yes,” counter N is incremented in step 30 and control is returned to step 20, where another unique identifier is assigned to address(N+1). If the result of the inquiry in step 25 is “no,” then method 10 ends. Those skilled in the art that method 10 illustrates just one method for assigning a unique identifier to an address and that other known methods may be used without departing from the principles of the invention.

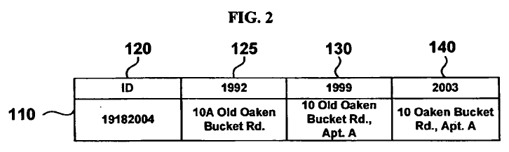

FIG. 2 is an exemplary table 100 that shows an address record 110 having a unique identifier 120 and a plurality of address elements 125, which was later assigned a plurality of address elements 130 and, later still, a plurality of other address elements 140 according to an embodiment of the present invention. The first row of table 100 indicates the year associated with a particular plurality of address elements. According to such an embodiment, address record 110 was assigned unique identifier 120 in 1992. Thereafter, in 1999, address record 110 was reconfigured according to the plurality of address elements 130. In 2003, address record 110 was again changed, for example, to avoid confusion with another similarly named thoroughfare in the same town. Thus, FIG. 2 shows that unique identifier 120, the pluralities of address elements 125, 130, and 140 all correspond to the same postal address (i.e., delivery location).

According to an embodiment of the present invention, historical changes to address elements, such as plurality of address elements 125 and pluralities of address elements 130 and 140, may be stored for later retrieval. Those of ordinary skill in the art will appreciate that access to historical address changes may be useful, for example, to minimize the effect of address changes on surveys repeated periodically at the same locations. For example, if a survey that includes address record 110 is conducted in 1992 and repeated in 1999, unique identifier 120 may be used confirm that 10A Old Oaken Bucket Road was included in the 1992 survey. In this way, the survey operator can examine the changes in survey responses over time, notwithstanding the fact that address record 110 changed in the interim.

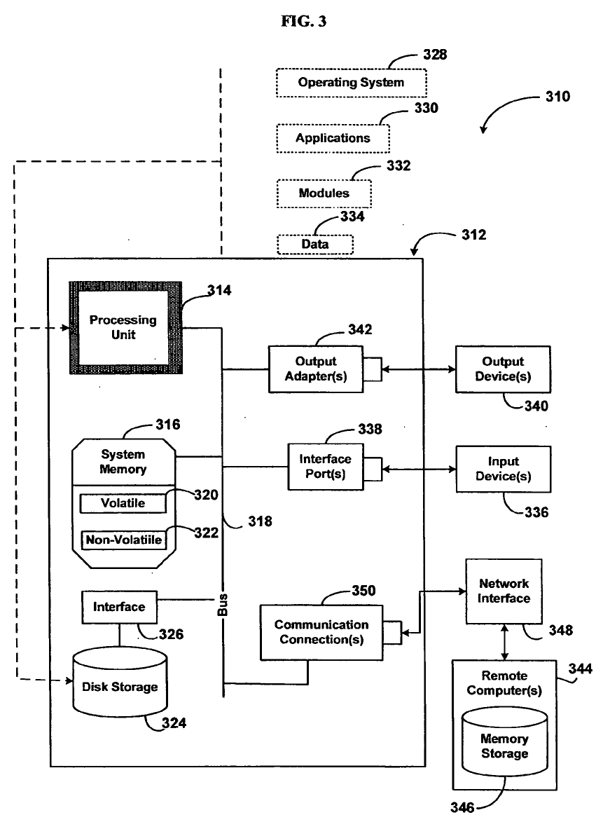

In order to provide context for the various aspects of the invention, FIG. 3 as well as the following discussion are intended to provide a brief, general description of a suitable computing environment in which the various aspects of the present invention may be implemented. For example, the operating infrastructure shown in FIG. 3 may be used to carry out the method shown in FIG. 1 and store the data shown in FIG. 2.

While the invention will be described below in the general context of computer-executable instructions of a computer program that runs on a computer and/or computers, those skilled in the art will recognize that the invention also may be implemented in combination with other program modules. Generally, program modules include routines, programs, components, data structures, and other aspects that perform particular tasks and/or implement particular abstract data types. Moreover, those skilled in the art will appreciate that the inventive methods may be practiced with other computer system configurations, including single-processor or multiprocessor computer systems, mini-computing devices, mainframe computers, as well as personal computers, hand-held computing devices, microprocessor-based or programmable consumer electronics, and the like.

FIG. 3 is an exemplary environment 310 for implementing an embodiment of the present invention. Environment 310 includes a computer 312 that, in turn, includes a processing unit 314, a system memory 316, and a system bus 318. The system bus 318 couples system components including, but not limited to, the system memory 316 to the processing unit 314. The processing unit 314 can be any of various available processors. Dual microprocessors and other multiprocessor architectures also can be employed as the processing unit 314.

Computer 310 also includes removable/non-removable, volatile/non-volatile computer storage media. Disk storage 324 shown in FIG. 3 may be used, for example, to store the information generated in FIG. 1 and illustrated in FIG. 2. The computer readable medium can be any available medium that can be accessed by a general purpose or special purpose computer. By way of example, and not limitation, such a computer readable medium can comprise RAM, ROM, electrically erasable programmable read only memory (EEPROM), CD-ROM or other optical disk storage, magnetic disk storage or other magnetic storage devices, or any other medium that can be used to store desired executable instructions or data fields and that can be accessed by a general purpose or a special purpose computer.

It is to be appreciated that FIG. 3 describes software that acts as an intermediary between users and the basic computer resources described in suitable operating environment 310. Such software includes an operating system 328. Operating system 328, which can be stored on disk storage 324, acts to control and allocate resources of the computer system 312. System applications 330 take advantage of the management of resources by operating system 328 through program modules 332 and program data 334 stored either in system memory 316 or on disk storage 324. Furthermore, it is to be appreciated that the present invention can be implemented with various operating systems or combinations of operating systems.

The computer readable medium tangibly embodies a program, functions, and/or instructions that cause the computer system to operate in a specific and predefined manner as described herein. Those skilled in the art will appreciate, however, that the process described above, such as the process illustrated in FIG. 1, may be implemented at any level, ranging from hardware to application software and in any appropriate physical location. For example, the present invention may be implemented as software code to be executed by computer 312 using any suitable computer language and may be stored on any of the storage media described above, or can be configured into the logic of computer 312. Such software code may be executed by system 310 using any suitable computer language such as, for example, Java, Javascript, C++, C, C#, Perl, Visual Basic, Transact/Structure Query Language (T/SQL), database languages, APIs, various system-level SDKs, assembly, firmware, microcode, and/or other languages and tools.

Computer 312 can operate in a networked environment using logical connections to one or more remote computers, such as remote computer(s) 344. The remote computer(s) 344 can be a personal computer, a server, a router, a network PC, a workstation, a microprocessor based appliance, a peer device or other common network node and the like, and typically includes many or all of the elements described relative to computer 312. For purposes of brevity, only a memory storage device 346 is illustrated with remote computer(s) 344. Remote computer(s) 344 is logically connected to computer 312 through a network interface 348 and then physically connected via communication connection 350. Network interface 348 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 350 refers to the hardware/software employed to connect the network interface 348 to the bus 318. While communication connection 350 is shown for illustrative clarity inside computer 312, it can also be external to computer 312. The hardware/software necessary for connection to the network interface 348 includes, for exemplary purposes only, internal and external technologies such as, modems including regular telephone grade modems, cable modems, DSL modems, power modems, ISDN adapters, and Ethernet cards. According to other embodiments, network interface 348 may capture data wirelessly through, for example, PCS, cellular, Bluetooth, 802.11, WiFi, Infrared, radio frequency, or other wireless technology.

These are representative components of an information processing system whose operation is well understood. Furthermore, those of ordinary skill in the art will appreciate that system 310 of FIG. 3 is exemplary only and that the present invention can operate within a number of different computer systems including general-purpose computer systems, embedded computer systems, and stand-alone computer systems specially adapted for applications relating to data processing or a distributed computing network.

While the foregoing has been with reference to a few specific embodiments of the invention, it will be appreciated by those skilled in the art that changes of these embodiments may be made without departing from the principles and spirit if the invention, the scope of which is defined by the appended claims.

What is claimed is:

1. A method for coding a plurality of postal addresses, comprising:
associating an identifier with a postal address having a first plurality of elements; and
associating the identifier with a second plurality of elements if the second plurality of elements is associated with the postal address.

2. The method of claim 1 wherein the identifier is alphanumeric.

3. The method of claim 1 wherein the first plurality of elements includes street number and street name.

4. The method of claim 1 further comprising
inputting the first plurality of elements, the second plurality of elements, and the identifier into a searchable storage entity.

5. The method of claim 4 further comprising
searching the searchable storage entity based on user-supplied criteria for a result.

6. The method of claim 5 further comprising
displaying the result a graphical display device.

7. A computer storage medium having stored thereon instructions causing a computer to perform the steps of claim 1.

8. An information system, comprising:
a database stored in memory, the database comprising a postal address having a first plurality of elements and a second plurality of elements, and wherein the postal address is associated with an identifier.

9. The system of claim 8 further comprising
means for receiving a query based on user-supplied criteria.

10. A method for selling access to the system of claim 8, the method comprising:
transferring funds to an operator of the system in exchange for access to the system.

11. A system for coding a plurality of postal addresses, comprising:
means for associating an identifier with a postal address having a first plurality of elements; and
means for associating the identifier a second plurality of elements if the second plurality of elements is associated with the postal address.
